(19) United States
(12) Patent Application Publication
(10) Pub. No.: US 2026/0316882 A1
(43) Pub. Date: Oct. 15, 2026

(54) Electric Bicycle with Emergency Running Strategy

(71) Applicant: ZF Friedrichshafen AG, Friedrichshafen (DE)

(72) Inventors: Alexander Jungaberle, Schlier (DE); Uwe Schraff, Markdorf (DE); Markus Wallner, Friedrichshafen (DE)

(21) Appl. No.: 19/117,182

(22) PCT Filed: Sep. 29, 2022
(86) PCT No.: PCT/EP2022/077237

§ 371 Date: Mar. 31, 2025

(51) Int. Cl. B62M 6/50; B62J 43/13; B62M 6/90; B62M 25/08

(52) U.S. Cl. CPC B62M 6/50; B62J 43/13; B62M 6/90; B62M 25/08

(57) ABSTRACT

A method for open-loop control of an electric bicycle, with the electric bicycle including a drive motor, an electric gear shifting mechanism, and a battery configured for supplying power both to the drive motor and to the electric gear shifting mechanism. the method includes determining a state of charge of the battery, and switching from a first operating state to a second operating state when the state of charge falls below a first threshold value. The drive motor and the electric gear shifting mechanism are operated in a normal state during the first operating state. During the second operating state, at least one of a power consumption of the drive motor is limited or the electric gear shifting mechanism is switched to a limited operating mode.

### CROSS-REFERENCE TO RELATED APPLICATION

The present application is a nationalization of PCT/EP2022/077237 filed in the European Patent Office on Sep. 29, 2022, the entirety of which is incorporated by reference for all purposes.

### FIELD OF THE INVENTION

The present invention relates generally to a method for the open-loop control of an electric bicycle, in which a drive motor and an electric gear shifting mechanism are supplied energy from a common energy source. In particular, the present invention relates to an emergency running strategy for such an electric bicycle.

### BACKGROUND

Gear shifting mechanisms, such as derailleurs, which can be actuated mechanically and electrically are known from the prior art. Electric motor-assisted bicycles, which are also referred to in the following as electric bicycles, such as pedelecs or e-bikes, having various types of gear shifting mechanisms are also known.

In such electric bicycles, problems can arise when both the electric gear shifting mechanism and the electric motor for assisting the propulsion are supplied from the same energy store, or the same battery. In such a situation in particular, it is to be expected that the electric gear shifting mechanism and the assistance by the motor will be limited when the state of charge of the battery falls below a certain value.

### SUMMARY OF THE INVENTION

The problem addressed by the present invention is therefore that of providing an electric bicycle and an open-loop control method for the electric bicycle, which method has improved behavior when the battery has a low state of charge.

A method according to one example aspect of embodiments of the present invention relates to a method for the open-loop control of an electric bicycle, where the electric bicycle has a battery and an electric gear shifting mechanism, and where the battery is configured to supply power both to the drive motor and to the electric gear shifting mechanism.

An electric bicycle is to be understood to mean a bicycle having a pedal device, which bicycle is operated at least intermittently with muscle power but also has a drive motor. The drive motor is configured to assist the propulsion of the electric bicycle and can also be referred to as a propulsion device or an electric machine. This electric machine is used to assist an operation of the pedal device, which is operated by muscle power. A battery is to be understood in this case to mean an energy storage device which can store electrical charge and which is preferably rechargeable via an external power supply. The term “battery” also applies to rechargeable batteries.

An electric gear shifting mechanism is to be understood in this case to mean a gear shifting mechanism which is actuated by electrical pulses and, for example, using these electrical pulses, a rear derailleur or a front derailleur is actuated. The actuation can be carried out automatically, i.e., on the basis of an automatic shifting system, or on the basis of a user request.

The first step of the method is to determine a state of charge of the battery. Such a state of charge refers to the remaining capacity of the battery in relation to the nominal value. A person skilled in the art knows various methods for determining the state of charge of a battery or of an energy store. The determination of a state of charge is also intended to re-fer to the determination of a state of discharge in this case.

In the next step, an operating state is to be switched from a first operating state to a second operating state when the state of charge falls below a first threshold value. Each of suchoperating states can be, for example, an operating state of the open-loop control of the electric bicycle, i.e., an internal operating state of the control device of the electric bicycle. A threshold value can be defined in this case as any value between a full charge and a full discharge of the battery.

In the first operating state, the drive motor and the electric gear shifting mechanism are to be operated in a normal state. A normal state is to be understood to mean, for example, operation without any limitation of the particular performance or functionality. A predefined behavior of the components can also be considered to be a normal state.

In the second operating state, either the power consumption of the drive motor is to be limited or the electric gear shifting mechanism is to be switched to a limited operating mode.

In order to reduce the power consumption, for example, the maximum power consumption of the drive motor can be limited to a predefined value. This means that the assistance, and thus, for example, the torque of the electric motor applied to the pedal unit or to a wheel of the bicycle, is limited. The output torque of the drive motor can also be limited since the power consumption is related to the input torque. Furthermore, a limitation to zero can be implemented such that the electric motor is switched off.

In the operation of an electric gear shifting mechanism in a limited operating mode, for example, functionalities and properties of the electric gear shifting mechanism can be limited such that an actuation deviating from the actuation in the normal state is carried out. Examples include changing the shifting characteristics, suppressing the actuation, shifting to a predetermined emergency gear, or the like.

Correspondingly, by switching to the second operating state, it can be ensured that the effects of a lower state of charge of the battery on the functionality, in particular, of the electric gear shifting mechanism, are reduced, since the functionality of the electric gear shifting mechanism is ensured by reducing the power consumption of the drive motor or reducing this power consumption to zero. In addition, the functionality of the electric gear shifting mechanism can be ensured by changing the shifting characteristics of the gear shifting mechanism.

In one example aspect of embodiments of the invention, in the second operating state, the power consumption can be limited by derating the drive motor. Correspondingly, the motor power is reduced, which in turn reduces the power consumption of the motor. Therefore, the functionality, in particular of the electric gear shifting mechanism, can be ensured for a longer period of time.

In another example aspect of embodiments of the invention, in the second operating state, the power consumption can be limited by switching off the drive motor. Since the power consumption of the motor is therefore reduced to zero, it is ensured that the electric gear shifting mechanism is kept operational for a considerably longer period of time.

In another example aspect of embodiments of the invention, in the second operating state, the electric gear shifting mechanism can be switched to a limited operating mode such that, using the gear shifting mechanism, a shift to a predefined emergency gear is carried out and, preferably, further gear change operations are suppressed. A predefined emergency gear can be predefined, for example, by a user via an application. If the threshold value is reached, the gear shifting mechanism therefore shifts to this predefined emergency gear. This permits the gear shifting mechanism to shift to a gear in which propulsion purely by muscle power is possible even when the electrical assistance by the drive motor has failed. If further gear change operations are then suppressed, the user can no longer shift out of this emergency gear and, therefore, propulsion in the emergency gear is ensured.

In another example aspect of embodiments of the invention, in the second operating state, the electric gear shifting mechanism is switched to an operating mode which is limited such that manual gear changes by the user are prevented and gear change operations are controlled according to an automatic gear shifting system. Gear change requests received from the user, for example, via an input device, can be suppressed. Due to the gears being selected using an automatic gear shifting system, a control behavior can then be formed which is suitable for the degree of assistance which is still possible and for the number of gear changes which are still possible. For example, a gear change can be carried out much fewer times than in a usual automatic mode, in order to reduce the power consumption of the electric gear shifting mechanism. Furthermore, for example, gear selection can be carried out only such that, in the event that the state of charge of the battery required for a gear change is fallen below, propulsion solely by muscle power is also made possible in the currently selected gear.

In another example aspect of embodiments of the invention, a third operating state is formed, which is switched to when the state of charge falls below a second threshold value. This second threshold value can be, for example, lower than the first threshold value.

In addition, in the third operating state, the aforementioned possible open-loop controls of the electric gear shifting mechanism or of the power consumption of the drive motor can be formed. It is also possible to implement measures which are suitable for multiple stages when certain states of charge are fallen below in succession.

For example, initially in a first step, and thus in the second operating mode, the power consumption of the electric motor can be reduced by a derating. In a further step, and thus in the third operating state, a switch to a predefined emergency gear can then be carried out in order to ensure propulsion.

Consequently, the addition of another operating state having another threshold makes it possible to implement a suitable sequence of measures in order to ensure the functionality of the electric motor and/or of the electric gear shifting mechanism for as long as possible in a suitable way even when the state of charge of the battery decreases.

According to the invention, in another example aspect of embodiments of the invention, a fourth operating state having a third threshold is to be provided. This can also be formed in accordance with the comments presented above.

The addition of a fourth operating state makes it possible to more precisely form the open-loop control in accordance with the state of charge.

For example, initially, a derating of the electric motor can be carried out in the second operating state, then, in a third operating state, only an automatic shift can be permitted, as described above, and finally, in the fourth operating state, a shift into an emergency gear can be carried out, as described above.

This permits a further improved adaptation of the power of the electric motor and of the electric gear shifting mechanism according to the state of charge.

The aforementioned method steps are to be understood not to be limited to the represented order; instead, the method steps can also be carried out in another order if this is technically possible.

The present invention further relates to an electric bicycle having a battery, a drive motor, and an electric gear shifting mechanism, wherein the battery is configured to supply power both to the drive motor and to the electric gear shifting mechanism, and wherein the electric bicycle also has a control device, which is configured to carry out a method according to one of the aforementioned embodiments.

With respect to the definition of the terms, reference is made to the comments presented above.

A control device can be, for example, a microprocessor which is provided externally or in one of the other components described here. The control device can also be a software component in software, which is already present and is run on an existing microprocessor on a computation unit. A distribution of the functionalities of the control device onto multiple microprocessors can also be provided.

### BRIEF DESCRIPTION OF THE DRAWINGS

FIG. 1 shows a diagram with a representation of the change in the operating states according to one example aspect of embodiments of the invention.

FIG. 2 shows an operating sequence of the method according to one example aspect of embodiments of the invention.

FIG. 3 shows a schematic view of the device according to one example aspect of embodiments of the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

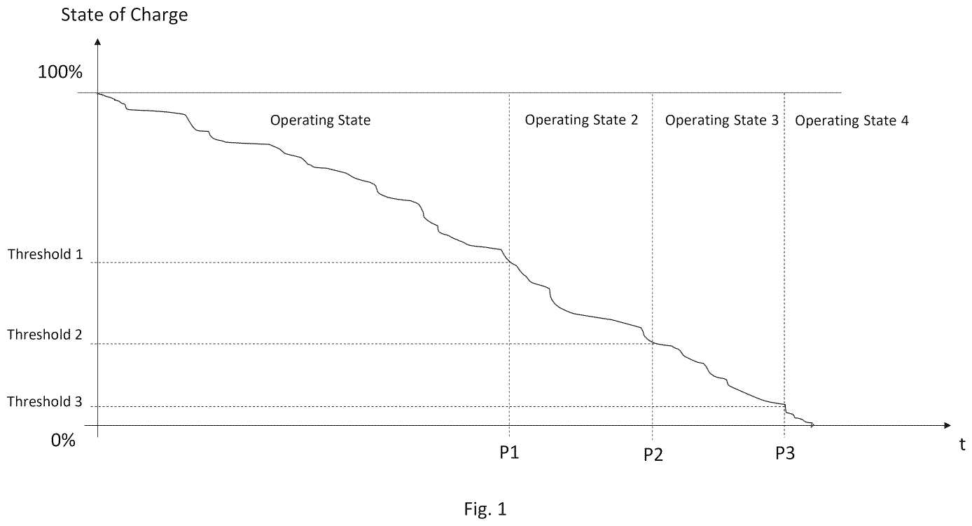

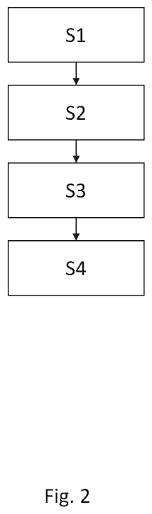

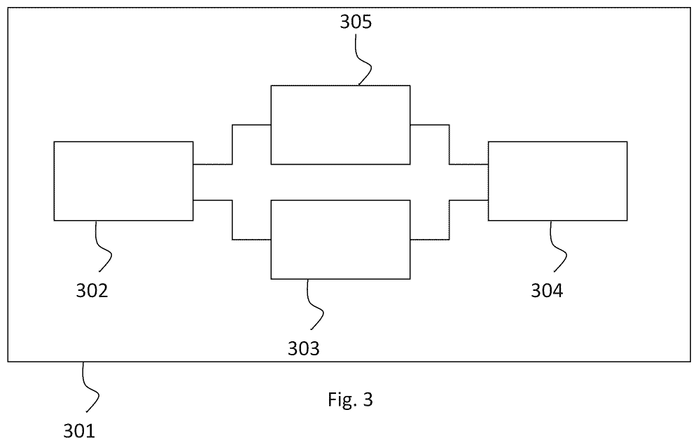

FIG. 1 shows the change in the operating states according to the state of charge of a battery. This is to be described in the following with reference to the method shown in FIG. 2 and with reference to the schematic view of the device shown in FIG. 3.

As is apparent, one possible progression of a state of charge over time is plotted in FIG. 1. Initially, the control device 302 of the bicycle 301 shown in FIG. 3 determines the state of charge of the battery 304 at step S1 in FIG. 2. If it is established that the state of charge of the battery 304 has fallen below a first threshold value (Threshold 1), as is the case at the point in time P1 in FIG. 1, a switch from a first operating state 1 into the second operating state 2 is carried out at step S2 in FIG. 2.

In this step, in the present example, initially a derating of the drive motor 303 shown in FIG. 3 is carried out, i.e., the power consumption of the drive motor 303 is limited, in order to maintain the functionality of the drive motor 303 and of the electric gear shifting mechanism 305 for as long as possible.

If, in the further progression to the point in time P2, it is then established that the state of charge of the battery 304 has fallen below the second threshold value (Threshold 2), a switch to the third operating state 3 is carried out at the point in time P2 shown in FIG. 1 at step S3 in FIG. 2. In this step, in the present example, the power consumption of the drive motor 303 is reduced to zero such that the drive motor 303 is switched off. Therefore, shifting using the electric gear shifting mechanism 305 is still possible for a considerably longer period of time, since the drive motor 303 consumes no electrical power.

If it is established at the point in time P3 shown in FIG. 1 that the third threshold value (Threshold 3) has also been fallen below, the open-loop control switches to the fourth operating state 4 at step S4 in FIG. 2. In this step, in the present example, the electric gear shifting mechanism 305 is activated and a shift to an emergency gear is carried out, which emergency gear is established by the user, for example, in advance via an application. This emergency gear enables the rider to cover the remaining distance necessary with their bicycle even without changing gears.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

P1 point in time of the change from operating state 1 to operating state 2
P2 point in time of the change from operating state 2 to operating state 3
P3 point in time of the change from operating state 3 to operating state 4
S1 determining the state of charge
S2 switch to operating state 2
S3 switch to operating state 3
S4 switch to operating state 4
301 bicycle
302 control device
303 drive motor
304 battery
305 electric gear shifting mechanism

1-9. (canceled)

10. A method for open-loop control of an electric bicycle (301), the electric bicycle (301) comprising a drive motor (303), an electric gear shifting mechanism (305), and a battery (304) configured for supplying power both to the drive motor (303) and to the electric gear shifting mechanism (305), the method comprising:
determining (S1) a state of charge of the battery (304); and
switching (S2) from a first operating state to a second operating state when the state of charge falls below a first threshold value,
wherein the drive motor (303) and the electric gear shifting mechanism (305) are operated in a normal state during the first operating state; and
wherein, during the second operating state, at least one of a power consumption of the drive motor (303) is limited or the electric gear shifting mechanism (305) is switched to a limited operating mode.

11. The method of claim 10, wherein, during the second operating state, the power consumption of the drive motor (303) is limited by derating the drive motor (303).

12. The method of claim 10, wherein, during the second operating state, the power consumption of the drive motor (303) is limited by switching off the drive motor (303).

13. The method of claim 10, wherein, during the second operating state, the electric gear shifting mechanism (305) is switched to the limited operating mode such that a shift to a predefined emergency gear is carried out using the electric gear shifting mechanism (305) and further gear change operations using the the electric gear shifting mechanism (305) are suppressed.

14. The method of claim 10, wherein, during the second operating state, the electric gear shifting mechanism (305) is switched to the limited operating mode such that manual gear changes by a user are prevented and gear change operations are controlled according to an automatic gear shifting system.

15. The method of claim 10, further comprising switching (S3) to a third operating state when the state of charge falls below a second threshold value, wherein, during the third operating state:
the power consumption of the drive motor (303) is limited; or
the electric gear shifting mechanism (305) is shifted to the limited operating mode, during the limited operating mode either a shift to a predefined emergency gear is carried out using the electric gear shifting mechanism (305) or manual gear changes by a user are suppressed and gear change operations are controlled according to an automatic gear shifting system.

16. The method of claim 15, wherein the second threshold value is lower than the first threshold value.

17. The method of claim 16, further comprising switching (S4) to a fourth operating state when the state of charge falls below a third threshold value, the third threshold value being lower than the second threshold value, wherein, during the fourth operating state:
the power consumption of the drive motor (303) is limited; or
the electric gear shifting mechanism (305) is shifted to the limited operating mode, during the limited operating mode of the fourth operating state, either the shift to the predefined emergency gear is carried out using the electric gear shifting mechanism (305) or the manual gear changes by the user are suppressed and the gear change operations are controlled according to the automatic gear shifting system.

18. An electric bicycle (301), comprising:
a drive motor (303),
an electric gear shifting mechanism (305),
a battery (304) configured to supply power both to the drive motor (303) and to the electric gear shifting mechanism (305), and
a control device (302) configured to carry out the method of claim 10.
